(19) United States
(12) Patent Application Publication
(10) Pub. No.: US 2008/0228983 A1
(43) Pub. Date: Sep. 18, 2008

(54) ELECTRONIC DEVICE TO WHICH AN OPTION DEVICE CAN BE MOUNTED AND A RECORDING MEDIUM

(76) Inventor: Yoshito NISHIHARA, Chiba (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/044,270

(22) Filed: Mar. 7, 2008

(30) Foreign Application Priority Data
Mar. 14, 2007 (JP) 2007-065590
Feb. 4, 2008 (JP) 2008-024343

(51) Int. Cl. G06F 13/00

(52) U.S. Cl. 710/303

(57) ABSTRACT

The present invention relates to an electronic device enabling an option configuration including an option device to be displayed on an information processing apparatus even if the information processing apparatus does not know the option device. The electronic device includes a storage unit storing respective device information items of the electronic device and the option devices; an option determination unit determining which option device is currently mounted to the electronic device; an option position detection unit detecting a position of the option device determined by the option determination unit relative to the electronic device; and an option configuration information generation unit generating option configuration information for displaying on the display unit of the information processing apparatus based on the device information items in the storage unit, a determination result of the option determination unit and the position of the option device detected by the option position detection unit.

### BACKGROUND OF THE INVENTION

1. Field of the Invention

The present invention relates to an electronic device that is connected to an information processing apparatus with a display device and to which one or more option devices can be mounted. The present invention also relates to a recording medium including one or more instructions of operation programs running on the electronic device.

2. Description of the Related Art

In cases where an information processing apparatus such as a personal computer (PC) is coupled via a network or serially to a peripheral device such as a printer, a scanner and a facsimile (FAX), the information processing apparatus includes device drivers for converting data generated or viewed by means of applications installed therein into device interpretable data. For example, in cases of the peripheral device being an image forming apparatus such as a laser printer (LP) and a multifunction peripheral (MFP), a printer driver dedicated to the image forming apparatus is commonly installed in the information processing apparatus to convert data generated by applications into printer language (PDL) data interpretable by the image forming apparatus.

A printer driver has a function of displaying images to inform users of the status of the current option configuration of one or more printers coupled to a PC. In order to fulfill the function, the printer driver includes option configuration information of the multiple printers, respective images for the printers and associated option devices, and position information used to display the images at appropriate positions. In addition, there are some known techniques for obtaining information regarding the printer type and option devices from connected printers and displaying option configurations of the printers based on the obtained information.

Conventionally, for example, when a printer connection port is switched to another printer, a printer driver corresponding to the printer must be installed. In order to eliminate the installation, a printer system that can store several device dependent modules in a PC in advance, acquire device type information from the connected printer through two-way communication and use a suitable one of the device dependent modules has been proposed.

In the conventional printer system, option images are mounted to the device dependent modules preinstalled in the PC, and, thus, even if one printer connected to the PC is switched into another printer, the option configuration can still be displayed to users. If the other printer is unknown to the current printer drivers, however, the option configuration of the other printer can no longer be displayed to the users. In this case, according to the conventional printer system, a device dependent module corresponding to the unknown printer must be installed in the PC.

### SUMMARY OF THE INVENTION

It is one general object of the present invention to address the above-mentioned problem. A specific object of the present invention is to provide an electronic device for enabling an option configuration of an electronic device including an option device to be displayed on an information processing apparatus even if the information processing apparatus does not recognize an option device connected to the electronic device. Another specific object of the present invention is to provide a recording medium including one or more instructions of operation programs running on the electronic device.

In order to achieve the above objects, one feature of the present invention relates to an electronic device connected to an information processing apparatus having a display unit, one or more option devices being mounted to the electronic device, the electronic device comprising: a storage unit storing respective device information items of the electronic device and the option devices; an option determination unit determining which option device is currently mounted to the electronic device; an option position detection unit detecting a position of the option device determined by the option determination unit relative to the electronic device; and an option configuration information generation unit generating option configuration information for displaying on the display unit of the information processing apparatus based on the device information items in the storage unit, a determination result of the option determination unit and the position of the option device detected by the option position detection unit.

Another feature of the present invention relates to an electronic device connected to an information processing apparatus having a display unit, one or more option devices being mounted to the electronic device, the electronic device comprising: storage means for storing respective device information items of the electronic device and the option devices; option determination means for determining which option device is currently mounted to the electronic device; option position detection means for detecting a position of the option device determined by the option determination means relative to the electronic device; and option configuration information generation means for generating option configuration information for displaying on the display unit of the information processing apparatus based on the device information items in the storage means, a determination result of the option determination means and the position of the option device detected by the option position detection means.

Another feature of the present invention relates to a recording medium comprising one or more instructions which, when executed by an electronic device connected to an information processing apparatus having a display unit, one or more option devices being mounted to the electronic device, cause the electronic device to perform the steps of: storing respective device information items of the electronic device and the option devices; determining which option device is currently mounted to the electronic device; detecting a position of the option device determined in the determination step relative to the electronic device; and generating option configuration information for displaying on the display unit of the information processing apparatus based on the device information items, a determination result of the determination step and the position of the option device detected in the detection step.

Other objects, features and advantages of the present invention will become more apparent from the following detailed description when read in conjunction with the accompanying drawings.

### BRIEF DESCRIPTION OF THE DRAWINGS

FIG. 1 shows an exemplary network environment according to one embodiment of the present invention;

FIG. 2 shows an exemplary hardware configuration of an information processing apparatus according to one embodiment of the present invention;

FIG. 3 shows an exemplary functional configuration of an information processing apparatus according to one embodiment of the present invention;

FIG. 4 shows an exemplary hardware configuration of an electronic device according to one embodiment of the present invention;

FIG. 5 shows an exemplary functional configuration of an electronic device according to one embodiment of the present invention;

FIG. 6 is a flowchart of an option information display operation according to a first embodiment of the present invention;

FIG. 7 shows an exemplary data structure of coordinate information according to the first embodiment;

FIG. 8 shows an exemplary Extended Markup Language (xml) format description of the coordinate information of FIG. 7;

FIG. 9 shows an exemplary json format description of the coordinate information of FIG. 7;

FIG. 10 is a flowchart of an option position detection operation according to the first embodiment;

FIG. 11 shows exemplary images in an option image storage unit according to the first embodiment;

FIG. 12 shows an exemplary data structure of option configuration information generated according to the first embodiment;

FIG. 13 shows an exemplary data structure of option position information in the option configuration information of FIG. 12;

FIG. 14 shows an exemplary image of an option configuration displayed by a printer driver based on the option configuration information of FIG. 12;

FIG. 15 a flowchart of an option information display operation according to a second embodiment of the present invention;

FIG. 16 shows an exemplary data structure of an image name detection table according to the second embodiment;

FIG. 17 shows an exemplary xml format description of the image name detection table of FIG. 16;

FIG. 18 shows an exemplary json format description of the image name detection table of FIG. 16;

FIG. 19 is a flowchart of an image name detection operation according to the second embodiment;

FIG. 20 shows exemplary images in the option image storage unit according to the second embodiment; and

FIG. 21 shows an exemplary data structure of option configuration information generated according to the second embodiment.

### DETAILED DESCRIPTION OF THE PREFERRED EMBODIMENTS

The present invention relates to an electronic device connected to an information processing apparatus having a display unit, one or more option devices being mounted to the electronic device, the electronic device comprising: a storage unit storing respective device information items of the electronic device and the option devices; an option determination unit determining which option device is currently mounted to the electronic device; an option position detection unit detecting a position of the option device determined by the option determination unit relative to the electronic device; and an option configuration information generation unit generating option configuration information for displaying on the display unit of the information processing apparatus based on the device information items in the storage unit, a determination result of the option determination unit and the position of the option device detected by the option position detection unit.

According to the feature of the present invention, even if an option device connected to an electronic device is unknown to an information processing apparatus connected to the electronic device, it is possible to display the associated option configuration on the information processing apparatus to inform users of the option device. The term “option” or “option device” used herein may refer to any devices that may be connected internally or externally to an electronic device for selectively extending functions of the electronic device after manufacturing thereof.

In one embodiment of the present invention, the device information items may include respective images of the electronic device and the option devices.

According to the embodiment, the storage unit only has to include image data of the electronic device itself and one or more option devices that may be mounted to the electronic device, resulting in reduction in the memory size of the storage unit.

In another embodiment of the present invention, the option configuration information generation unit may acquire an image of the electronic device and an image of the option device determined by the option determination unit from the storage unit and further acquire position information indicative of the position of the option device detected by the option position detection unit in order to generate the option configuration information, and the option configuration information may include the image of the electronic device and the image and the position information of the option device currently mounted to the electronic device.

According to the embodiment, the information processing apparatus connected to the electronic device of the present invention can display the option configuration image of the electronic device to users by arranging respective images in the option configuration information in accordance with the position information in the option configuration information received from the electronic device.

In a further embodiment of the present invention, the image of the option device stored in the storage unit may include position information of one or more positions where the option device is allowed to be mounted to the electronic device, and the option configuration information generation unit may acquire the image of the electronic device and the image of the option device determined by the option determination unit from the storage unit in order to generate the option configuration information, and the image of the option device may include position information corresponding to the position of the option device detected by the option position detection unit, and the option configuration information may include the image of the electronic device and the image including the position information of the option device currently mounted to the electronic device.

According to the embodiment, the information processing apparatus connected to the electronic device of the present invention can display the option configuration image of the electronic device to users by combining respective images, including the position information, in the option configuration information received from the electronic device.

In a still further embodiment of the present invention, the device information items may be stored in the storage unit in compressed form.

According to the embodiment, even if there were a large number of types of option devices that may be mounted to the electronic device, or even if the position information were included in the images associated with the option devices that may be mounted to the electronic device and there are a large number of arrangement patterns of the option devices, the capacity of the storage unit could still be efficiently used.

In order to achieve the above-mentioned objects, a recording medium of the present invention includes one or more instructions which, when executed by the electronic device, cause the electronic device to perform the steps of the present invention.

According to the feature of the present invention, an information processing apparatus does not have to possess predefined option configuration information of an electronic device in advance, and the electronic device can generate the option configuration information and transmit it to the information processing device. As a result, even if the information processing apparatus does not know an option device connected to the electronic device, the information processing apparatus can display the option configuration.

Preferred embodiments of the present invention will be described in detail with reference to the accompanying drawings. The embodiments will be described in context of a printer, but the present invention is not limited to it.

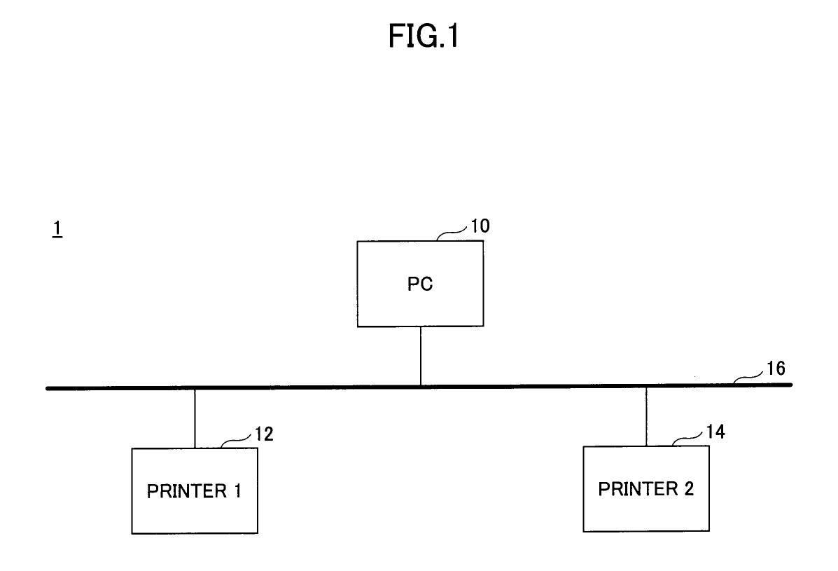

FIG. 1 shows an exemplary network environment where one or more printers according to one embodiment of the present invention may be used.

In FIG. 1, an image forming system 1 includes a personal computer (PC) 10, a first printer 12, a second printer 14 and a network 16 through which these components are communicatively interconnected.

The PC 10 may be an information processing apparatus where a user interface (UI) can be displayed under control of an operating system (OS). In other embodiments, other types of computers such as Personal Digital Assistant (PDA) and a mobile phone may be used.

The first printer 12 and the second printer 14 may operate in accordance with requests from PC 10. In this embodiment, one or both of the printers 12 and 14 may be of some types of image forming apparatuses such as a laser printer (LP) or a multifunction peripheral (MFP).

In FIG. 1, one PC and two printers are illustrated, but any number of PCs and printers may be provided. In FIG. 1, the PC may be illustratively connected to the printers via a network such as LAN (Local Area Network) and the Internet. In other embodiments, the PC may be connected to the printers in the serial form via a Universal Serial Bus (USB) or other conventional serial buses.

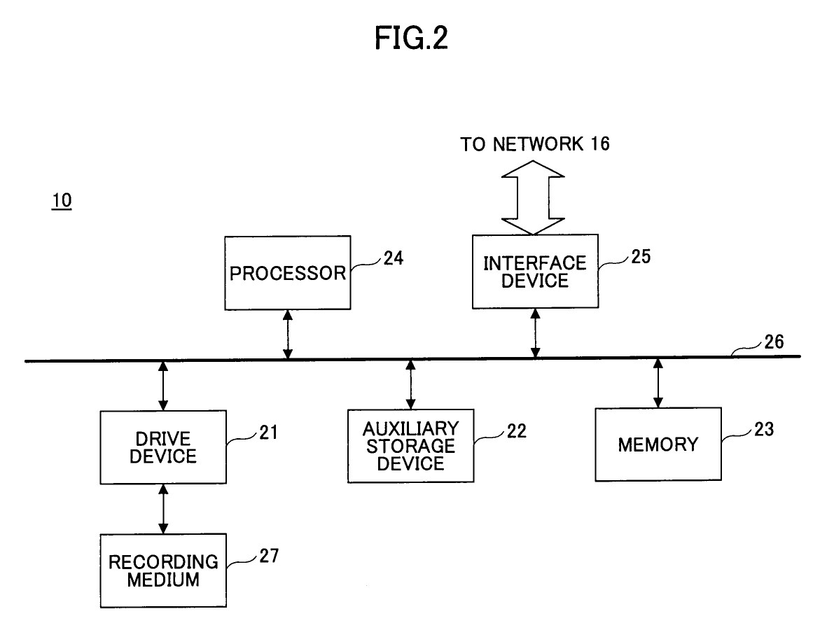

FIG. 2 shows an exemplary hardware configuration of the PC 10 of FIG. 1. As illustrated in FIG. 2 the PC 10 includes a drive device 21, an auxiliary storage device 22, a memory 23, a processor 24 and an interface device 25, which are interconnected via a bus 26. Programs running on the PC 10 are stored in a recording medium 27 such as a Compact Disk-Read Only Memory (CD-ROM).

The drive device 21 may serve to read the recording medium 27. Once the recording medium having one or more programs is mounted to the drive device 21, the programs are loaded from the recording medium 27 to the auxiliary storage device 22 via the drive device 21. In this embodiment, device drivers such as printer drivers will be described as the programs stored in the recording medium 27.

The auxiliary storage device 22 may store one or more loaded programs as well as necessary files and data.

The processor 24 may read and store in memory 23 one or more programs from the auxiliary storage device 22 in response to an activation instruction of the programs.

The processor 24 may perform one or more functions of the PC 10 in accordance with the programs in the memory 23.

The interface device 25 may serve to communicate the PC 10 to the network 16 of FIG. 1.

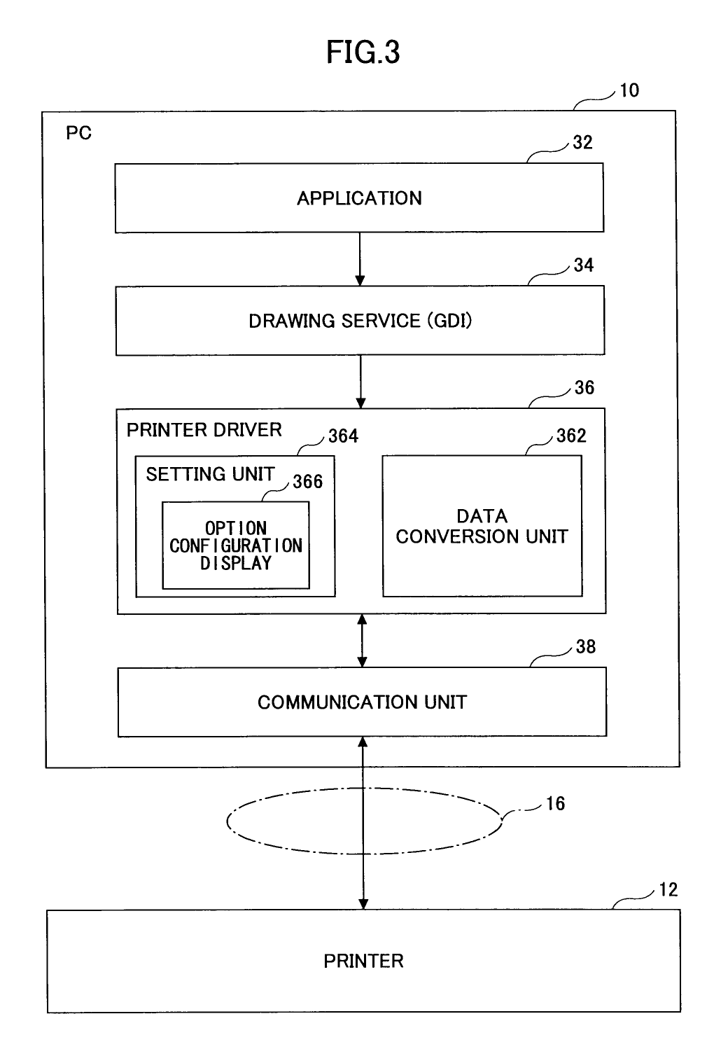

FIG. 3 shows an exemplary functional configuration of the PC 10 of FIG. 1. As illustrated in FIG. 3, the PC 10 is connected to the printer 12 via the network 16 and includes an application 32, a drawing service 34, a printer driver 36 serving as one example of the device drivers and a communication unit 38.

The application 32 may consist of one or more programs running on an operating system (OS) such as Microsoft Windows® and may be one of generic applications such as a documentation software item or a spreadsheet software item.

The drawing service 34 may be a drawing engine running on the OS and may be incorporated together with an interface between the application 32 and the drawing service 34 into Graphic Device Interface (GDI).

The printer driver 36 is a module for converting OS internal instructions into printer interpretable data, that is, printer language (PDL) data. The printer driver 36 includes a data conversion unit 362 for converting data requested for printing by the application 32 into printer interpretable data and a setting unit 364 for receiving a print setting from a user and causing it to be reflected to a printer output. The setting unit 364 includes an option configuration display unit 366 for displaying an option configuration of the target printer 12 in image form so that the user is enabled to establish a printer setting. The printer driver 36 may be commonly connected to the GDI 34 via an interface referred to as Device Driver Interface (DDI).

The communication unit 38 is a communication module for transmitting and receiving data to/from the printer 12 via the network and may include a spooler to spool PDL data generated in the printer driver 36. Because output operations of printers are significantly slower than operations of computers and applications in general, the spooler may promote the PC 10 to be rapidly released from the communication to the printer 12 compared to direct transmission of data to the printer 12, particularly in cases of the large data.

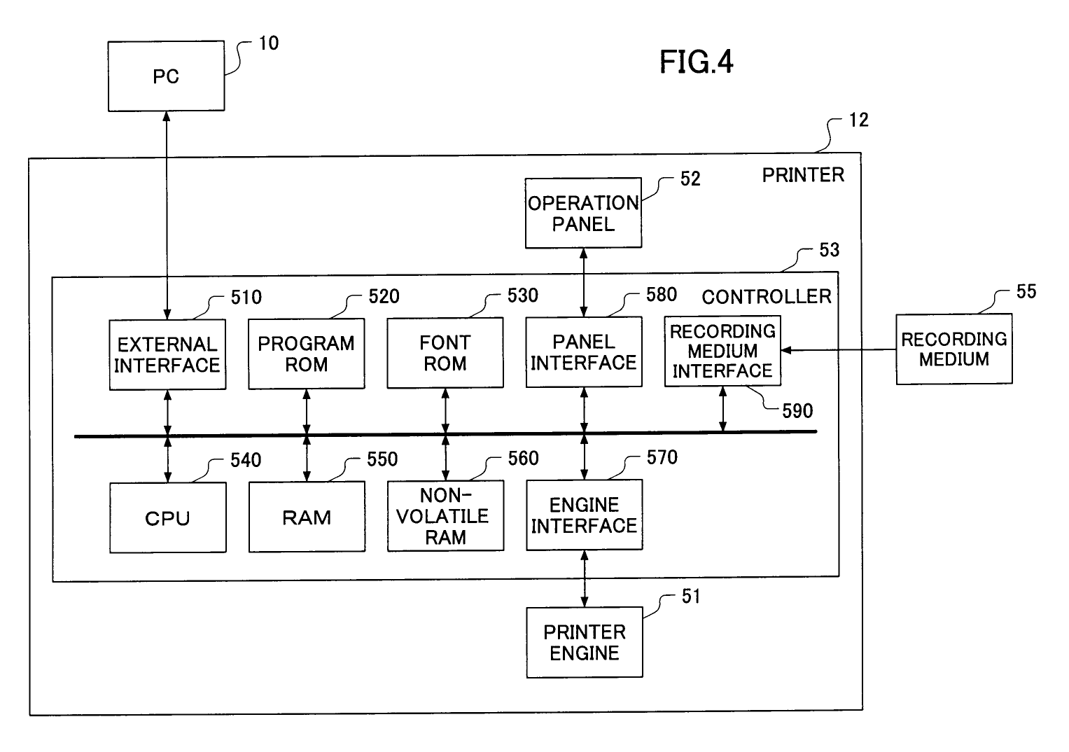

FIG. 4 shows an exemplary hardware configuration of the printer 12 of FIG. 1.

In FIG. 4, the printer 12 is connected to the PC 10 via a network as illustrated in FIG. 1 and includes a printer engine 51 for printing, an operation panel 52 for enabling a user to manipulate and set the image forming apparatus and for displaying the current status of the printer 12 and other information, and a controller 53 for controlling the components.

In further detail, the controller 53 may serve as a control mechanism for converting document data supplied from the PC 10 into image data in accordance with predefined control modes and/or control code supplied from the PC 10 and for supplying the image data to the printer engine 51. The controller 53 includes an external interface 510, a program storage unit 520, a font storage unit 530, a control unit 540, a temporary storage unit 550, a backup storage unit 560, an engine interface 570, a panel interface 580 and a recording medium interface 590.

The external interface 510 may serve as a transmission and reception unit for receiving commands and data from the PC 10 and for transmitting option configuration information to the PC 10.

The program storage unit 520 may serve as a storage unit for storing one or more programs to manage data within the controller 53 and control peripheral modules. The font storage unit 530 may serve as a storage unit for storing various types of fonts for use in printing. The program storage unit 520 and the font storage unit 530 may be embodied in ROM (Read Only Memory) or RAM (Random Access Memory).

The control unit 540 may serve as a data handler for handling data supplied from the PC 10 in accordance with the programs in the program storage unit 520. For example, the control unit 540 may be included in Central Processing Unit (CPU).

The temporary storage unit 550 may be a storage unit serving as a work memory for use in operation of the control unit 540, a buffer for managing and temporarily storing data supplied from the PC 10 in the unit of page, and a bitmap memory for converting data in a buffer into a printing pattern and storing the image data. The temporary storage unit 550 may be embodied in RAM.

The backup storage unit 560 may serve as a storage unit for storing data required to be kept even after the printer 12 is switched off. The backup storage unit 560 may be embodied in non-volatile RAM.

The engine interface 570 may serve as an interface unit for transmitting control signals to the printer engine 51 and receiving status signals from the printer engine 51.

The panel interface 580 may serve as an interface unit for communicating various signals to switch the status, the control mode and the font of the printer 12 to the operation panel 52.

The recording medium interface 590 may serve as an interface unit for loading the recording medium 55 storing programs. The programs loaded from the recording medium are stored in the program storage unit 520. Alternatively, after loaded by the recording medium interface 590, the programs may be directly used in the control unit 540 for data processing.

The above-mentioned components of the printer 12 may be interconnected via an internal common bus.

Next, an exemplary normal printing operation of the printer 12 of FIG. 4 will be described below. In response to receipt of data from the PC 10 via the external interface 510, the printer 12 uses the control unit 540 to sort the data into printing data as well as printing control data and other data. The printing data and the printing control data are converted into control codes, which are stored in the temporary storage unit 550. If the printing instruction and data received from the PC 10 have a data amount corresponding to more than one page, the control unit 540 first converts the control codes into image data and subsequently issues a printing start instruction to the printer engine 51 via the engine interface 570. In this way, the printer 12 uses the printer engine 51 to print out the data received from the PC 10. Based on the image data and control signals received from the controller 53, the printer engine 51 generates and develops an electrostatic latent image onto a photoconductor. Then, the printer engine 51 transfers and fixes the image on a transferring sheet supplied from a paper supplying unit for image formation.

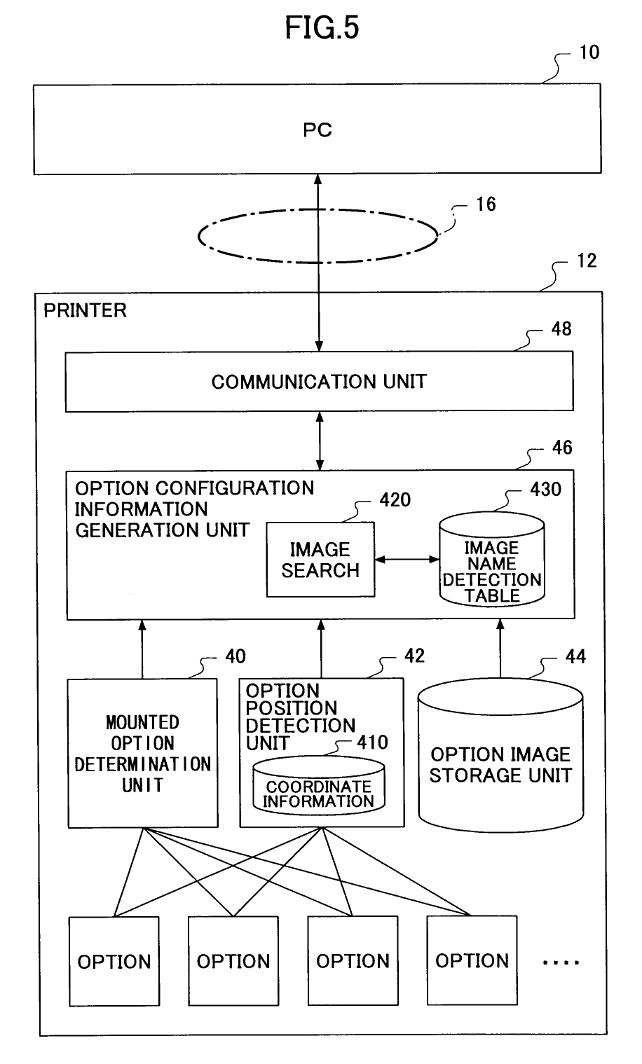

FIG. 5 shows an exemplary functional configuration of the printer 12 of FIG. 1. As illustrated in FIG. 5, the printer 12 is connected to the PC 10 via the network 16 and includes an option determination unit 40, an option position detection unit 42, an option image storage unit 44, an option configuration information generation unit 46 and a communication unit 48. The printer 12 may further include one or more option devices internally and/or externally. The components of the printers 12 may be interconnected via a bus.

The option determination unit 40 may serve as a module for determining which options have been mounted by installing and/or connecting to the printer 12.

The option position detection unit 42 may serve as a module for detecting the position of an option mounted to the printer 12 relative to the printer body and includes a coordinate information storage unit 410. The coordinate information storage unit 410 stores coordinate information to detect where the option device is mounted relative to the printer 12.

The option image storage unit 44 may serve as a device for storing an image of the printer 12 itself and images of options that can be mounted to the printer 12. The option image storage unit 44 may store the images in compressed form or uncompressed form.

The option configuration information generation unit 46 may serve as a module for generating option configuration information based on determination results of the option determination unit 40, detection results of the option position detection unit 42 and images stored in the option image storage unit 44. The option configuration information generation unit 46 includes an image search unit 420 and an image name detection table storage unit 430. The image search unit 420 may select an appropriate image to be retrieved from the option image storage unit 44 with reference to an image name detection table in the image name detection table storage unit 430 based on determination results of the option determination unit 40 and detection results of the option position detection unit 42.

The communication unit 48 may serve as a module for transmitting and receiving data to and from the PC 10 via the network 16.

Option information display operations of the PC 10 and the printer 12 as illustrated in FIGS. 1-5 according to some embodiments of the present invention will be described in detail below.

### First Embodiment

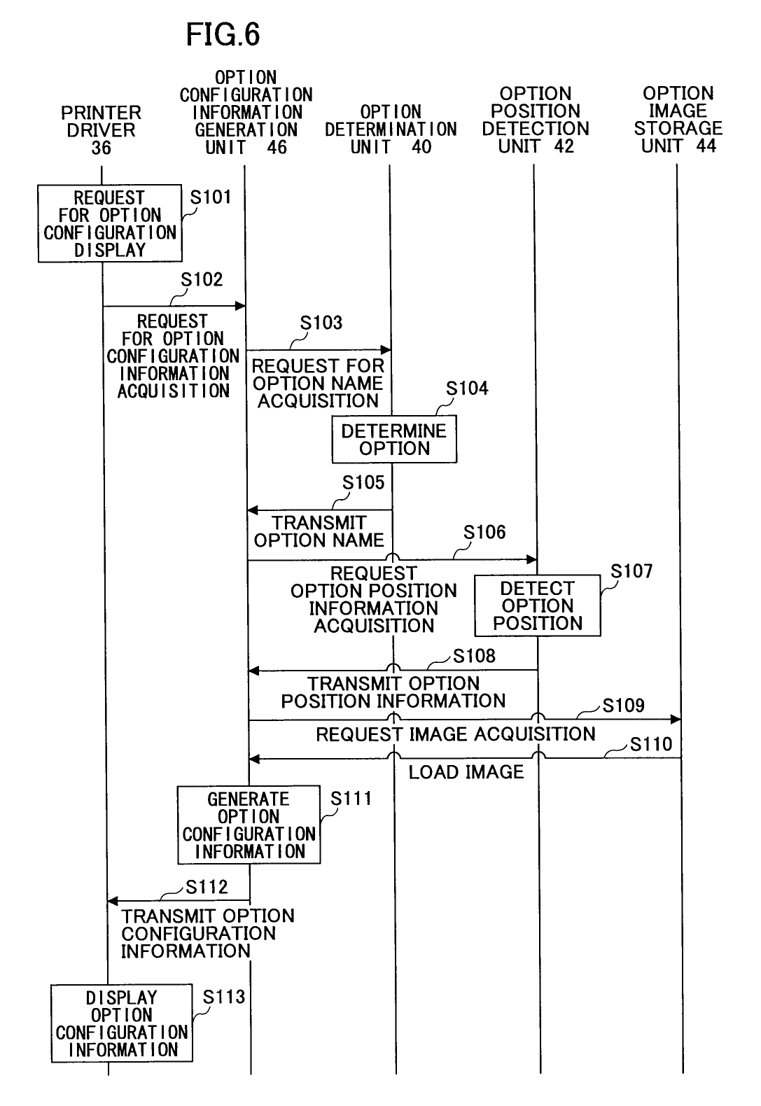

FIG. 6 is a flowchart of an option information display operation of the PC 10 and the printer 12 of FIGS. 1-5 according to the first embodiment of the present invention.

At step S101, the option information display operation starts with reception at the PC 10 of a request for displaying an option configuration of the printer 12 from a user via an input device (not shown) such as a mouse and a keyboard. At step S102, in response to this request, a printer driver 36 requests the printer 12 to acquire option configuration information. Upon receiving the acquisition request of the option configuration information from the printer driver 36 via the communication unit 48, the printer 12 requests the option configuration information generation unit 46 to generate the option configuration information.

At step S103, the option configuration information generation unit 46 requests the option determination unit 40 to determine which options are currently mounted to the printer 12 itself. Specifically, the option configuration information generation unit 46 requests the option determination unit 40 to acquire the device names of the options currently mounted. At step S104, in response to receipt of the request, the option determination unit 40 acquires the device names from the options to determine which options are currently mounted to the printer 12 itself. Then at step S105, the option determination unit 40 transmits the acquired option device names to the option configuration information generation unit 46.

At step S106, the option configuration information generation unit 46 requests the option position detection unit 42 to acquire position information of the options currently mounted to the printer 12. At step S107, in response to the request, the option position detection unit 42 detects the positions of the options currently mounted to the printer 12 relative to the position of the printer 12 itself. Then at step S108, the option position detection unit 42 transmits the position information indicative of the detected options to the option configuration information generation unit 46.

At step S109, the option configuration information generation unit 46 requests an image of the printer 12 itself and images of the options currently mounted to the printer 12 to the option image storage unit 44. Specifically, the option configuration information generation unit 46 requests the image of the printer 12 itself and the images of the options having the device names previously acquired from the option determination unit 40. Then at step S110, the option configuration information generation unit 46 reads the respective images of the printer 12 and target options from the images stored in the option image storage unit 44.

At step S111, the option configuration information generation unit 46 generates option configuration information based on the option device names and the position information as acquired in the above-mentioned steps as well as the respective images of the printer 12 and the options.

At step S112, the printer 12 transmits the option configuration information generated by the option configuration information generation unit 46 to the PC 10 requesting the option configuration information.

At step S113, the printer driver 36 of the PC 10 uses the option configuration display unit 366 to display an image indicative of the option configuration of the printer 12 on a display (not shown) based on the option configuration information acquired from the printer 12.

The option position detection operation of step S107 in FIG. 6 will be further described in detail below.

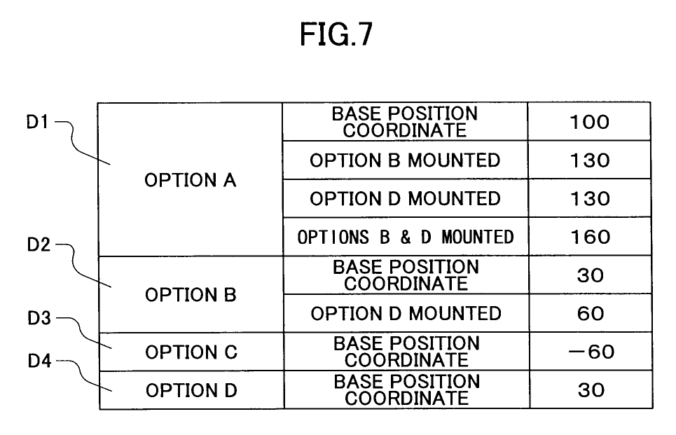

FIG. 7 shows exemplary coordinate information stored in table form in a coordinate information storage unit 410 of the option position detection unit 42. The coordinate information indicates where option devices should be mounted relative to the printer 12. In this embodiment, as illustrated in FIG. 7, the coordinate information may include data D1, D2, D3 and D4 indicative of options A, B, C and D, respectively.

The data D1 may include for the option A a base position coordinate of the option A relative to the printer 12 (simply referred to as a base position coordinate hereinafter) and respective sets of position coordinates of the option A in cases of the option A being mounted together with the option B, with the option D and with the options B and D.

For example, it is assumed that the left-side surface with respect to the front surface of the printer 12 may be set as a reference position and if a reference coordinate indicative of the reference position is set to be “0”, the left side and the right side with respect to the reference position are considered as a positive range and a negative range, respectively. In the illustration of FIG. 7, since the base position coordinate of the option A is “100”, it can be understood that the left-side surface of the option A is located 100 cm away from the reference position in the unit of centimeter (cm). Also, in the illustration of FIG. 7, the position coordinate of the option A is “130” in the case of the option B or D being additionally mounted. In this case, the option A is positioned relative to the printer 12 at 30 cm further away from the base position coordinate in the left direction. In other words, it is understood that each of the options B and D has the width of 30 cm and is arranged between the printer 12 and the option A. Accordingly, if both of the options B and D are mounted, the position coordinate of the option A becomes “160” as illustrated in FIG. 7.

The data D2 includes the base position coordinate of the option B relative to the printer 12 as well as a position coordinate of the option B corresponding to a case of the option B being mounted together with the option D. In the illustration of FIG. 7, the base position coordinate of the option B is “30”, and in the case of the option D being mounted, the position coordinate of the option B is “60”. Thus, the option B is positioned relative to the printer 12 in such a manner that the left-side surface is at 30 cm away from the reference position in principle. However, if the option D is also mounted, the option B is positioned relative to the printer 12 in such a manner that the left-side surface is at 30 cm (corresponding to the width of the option D) further away because of the presence of the option D.

The data D3 includes the base position coordinate of the option C relative to the printer 12. In the illustration of FIG. 7, the base position coordinate of the printer C is “−60”. Thus, the option C is always positioned relative to the printer 12 in such a manner that the left-side surface is located 30 cm away from the reference position in the left direction.

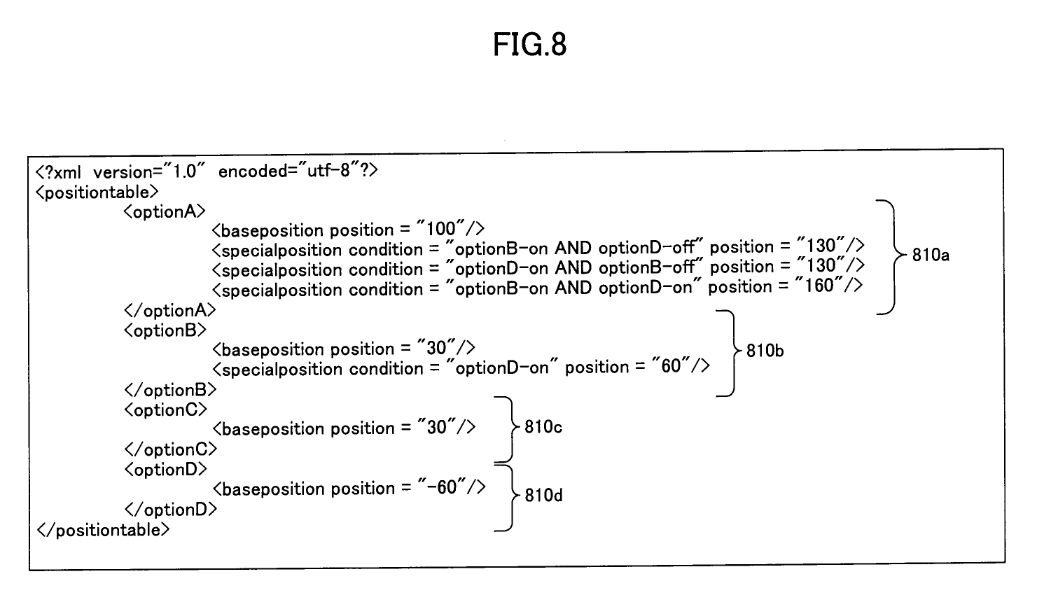

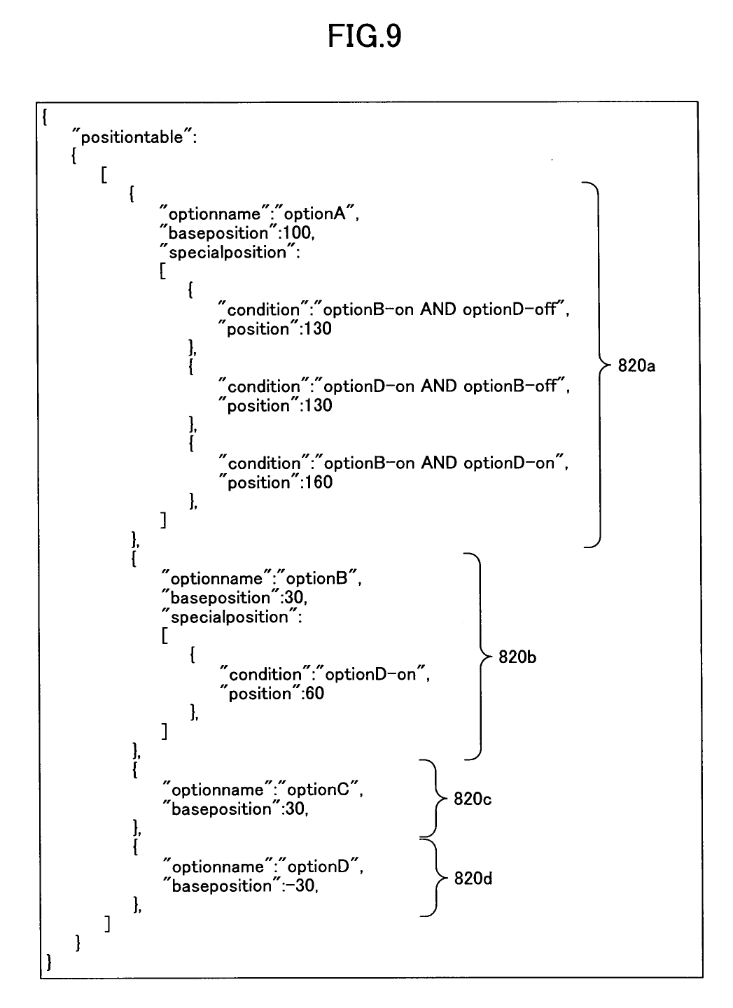

In fact, the coordinate information may be represented in xml format as illustrated in FIG. 8 or in json format as illustrated in FIG. 9.

In the xml format of FIG. 8, the descriptions 801a, 810b, 810c and 810d correspond to the position coordinates of the options A, B, C and D, that is, the data D1, D2, D3 and D4, respectively, of FIG. 7. In these descriptions, the term “baseposition” represents the base position coordinate, and the term “specialposition” represents a condition as to whether one or more other options are mounted as well as the position coordinate in the case when the condition is satisfied.

In the json format of FIG. 9, the descriptions 820a, 820b, 820c and 820d correspond to the position coordinate of the options A, B, C and D, that is, the data D1, D2, D3 and D4, respectively, of FIG. 7. Similarly, in these descriptions, the term “baseposition” represents the base position coordinate, and the term “specialposition” represents a condition as to whether one or more other options are attached as well as the position coordinate in the case when the condition is satisfied. The json format has one advantage over the xml format in that it can facilitate easy programming and simple processing. However, a suitable one of them may be used depending on applications.

In FIGS. 7-9, the coordinate information is specified to include the reference position coordinate of each option and the position coordinate thereof in cases of other options being mounted. However, the coordinate information may be specified to include the width of each option and the relative position relationship between the option and the printer as well as other options. The relative position relationship may consist of some position conditions such as “the option A is positioned at the left side of the printer” and “the option B is positioned between the printer and the option A”. In the xml format or the json format, desired position coordinates of certain options can be obtained in accordance with the position conditions by addition or subtraction of the respective width of the options.

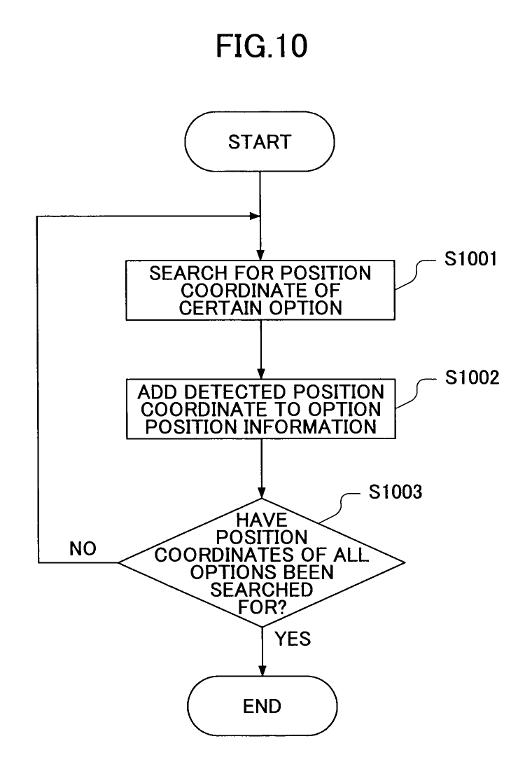

The option position detection unit 42 performs an option position detection operation described in conjunction with FIG. 10 based on the coordinate information as described in conjunction with FIGS. 7-9 and a list of options included in the option position information acquisition request transmitted from the option configuration information generation unit 46. FIG. 10 is a flowchart of an exemplary option position detection operation according to this embodiment.

The option position detection operation of FIG. 10 starts with reception at the option position detection unit 42 of an option position information acquisition request from the option configuration information generation unit 46. The option position information acquisition request may include a list of options including the device names of the options acquired at the previous steps S103-S105.

At step S1001, the option position detection unit 42 searches the coordinate information stored in the coordinate information storage unit 410 for a position coordinate of an option having a certain device name based on the device name in the option list. At step S1002, the option position detection unit 42 adds the search result to the option position information subsequently returned as a return value. At step S1003, the option position detection unit 42 determines whether all the device names in the option list have been searched for the position coordinate, and if not, the steps S1001 and S1002 are performed again. If all the device names in the option list have been searched for the position coordinate, the option position detection unit 42 returns option position information as a return value, and the option position detection operation is terminated.

Next, exemplary option configuration information generated at step S111 of FIG. 6 according to this embodiment will be described below.

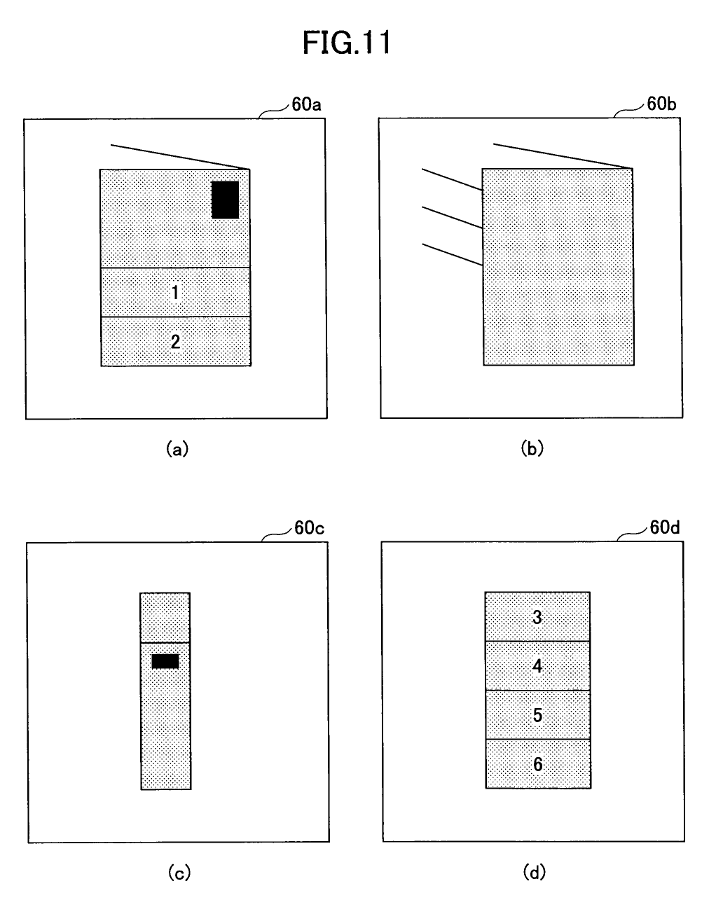

FIG. 11 shows exemplary images stored in the option image storage unit 44 of the printer 12 according to this embodiment. FIG. 11(a) shows an image 60a of the printer 12, and FIGS. 11(b)-(d) show respective images 60b-60d of options that can be mounted to the printer 12. In this embodiment, as illustrated in FIG. 6, the image 60b represents an output document ejection unit, also called a finisher, which can automatically sort and/or staple output documents. The image 60c represents a Z-folding unit that Z-folds output documents. The image 60d represents a high-capacity input paper tray that may be installed in addition to an input paper tray incorporated into the printer 12. These images may consist of bitmap format data (BMP file), for example.

If the options of the finisher, the Z-folding unit and the high-capacity input paper tray can be mounted to the printer 12, the four images 60a-60d as illustrated in FIG. 11 may be stored in advance in the option image storage unit 44 of the printer 12.

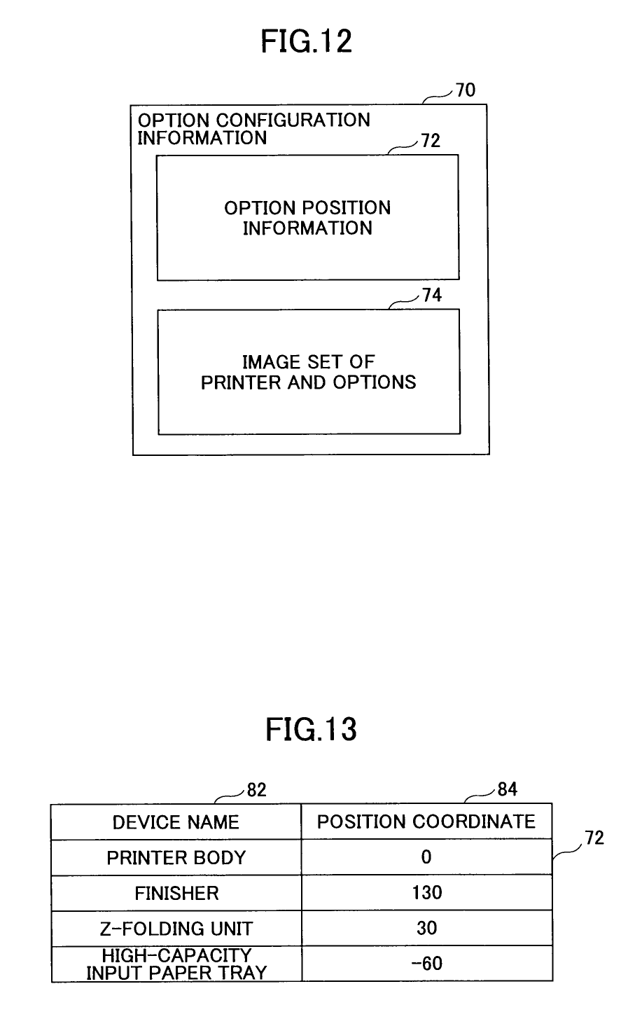

FIG. 12 shows an exemplary data structure of option configuration information generated by the option configuration information generation unit 46 of the printer 12 according to this embodiment. The option configuration information 70 of FIG. 12 includes option position information 72 and a set of images 74 associated with the printer 12 and options.

The option position information 72 may be obtained in an option position detection operation by the option position detection unit 42. In this embodiment, the option position information 72 indicates the current positions of the options relative to the printer 12. The set of images 74 is a collection of images associated with the printer 12 and currently mounted options loaded from the option image storage unit 44. In a printer to which the options of the finisher, the Z-folding unit and the high-capacity input paper tray can be mounted, for example, if all the options are mounted to the printer and the images 60a-60d are stored in the option image storage unit 44 as illustrated in FIG. 11, the set of images 74 includes the images 60a-60d.

Alternatively, the option position information 72 may be represented as shown in FIG. 13. FIG. 13 shows an exemplary data structure of the option position information 72 of FIG. 12.

In FIG. 13, the option position information 72 is represented in table form and includes columns 82 storing device names of options and rows 84 storing position coordinates of the options relative to the printer 12. If the finisher, the Z-folding unit and the high-capacity input paper tray are mounted to the printer 12, the columns 82 include the name of the printer 12 “Printer” such as the device name of the printer 12 as well as the names of the mounted options “Finisher”, “Z-folding unit” and “High-capacity input paper tray” such as the device names of the options. The reference coordinate is stored in the cell of the columns 84 corresponding to “Printer”. As stated previously, the options are arranged based on the relative distance from the reference position of the printer 12. In other words, the cells of the columns 84 corresponding to the options include values corresponding to (reference coordinate)+(relative distance from reference position). In this embodiment, as illustrated in FIG. 13, the cell corresponding to “Finisher” includes “130”, the cell corresponding to “Z-folding unit” includes “30”, and the cell corresponding to “High-capacity input paper tray” includes “−60”.

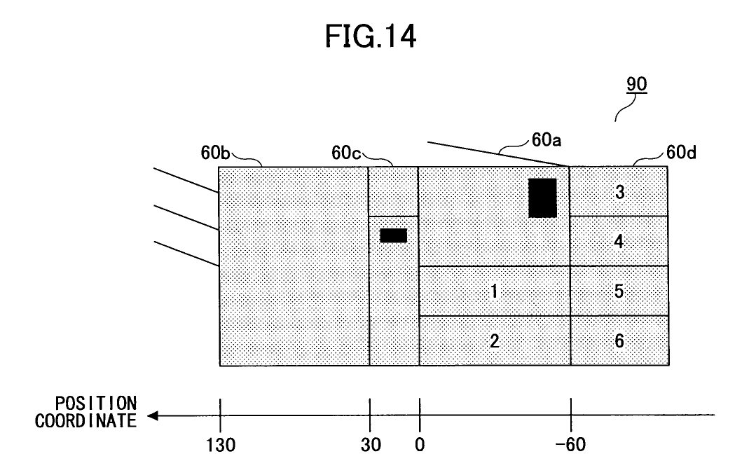

FIG. 14 shows an exemplary option configuration image displayed by a printer driver based on the option configuration information 70 as illustrated in FIG. 12.

The printer driver acquires option configuration information 70 of FIG. 12 from the printer and displays an option configuration image of the target printer 12 to a user based on the option configuration information 70. Specifically, the option configuration displaying unit 366 of the printer driver 36 sequentially sorts and displays the set of images 74 of the printer 12 and the options in the option configuration information 70 based on the option position information 72 in the option configuration information 70. In other words, an image 90 of an option configuration of FIG. 14 consists of images 60a-60d of the printer 12 and the options (finisher, Z-folding unit and a high-capacity input paper tray) as illustrated in FIG. 11. In FIG. 14, in order to facilitate the understanding of the present invention, assuming that the left-side surface of the printer 12 is set to have reference position represented as the reference coordinate “0”, a coordinate axis indicative of a relative distance of the left-side surface of an option from the reference position is shown.

According to an electronic device of this embodiment, an information processing apparatus does not have to possess option configuration information for the electronic device in advance, and even if an option device mounted to the electronic device is unknown to the information processing apparatus, the option configuration including the option device can be displayed. Also, an information processing apparatus connected to an electronic device according to this embodiment can display an option configuration of the electronic device in image form by arranging images in the option configuration information in accordance with the position information in the option configuration information received from the electronic device.

### Second Embodiment

An option information display operation of the PC 10 and the printer 12 as illustrated in FIGS. 1-5 will be described in detail below. In the second embodiment, option images in the option image storage unit 44 include some information regarding the positions where the options can be mounted to the printer 12.

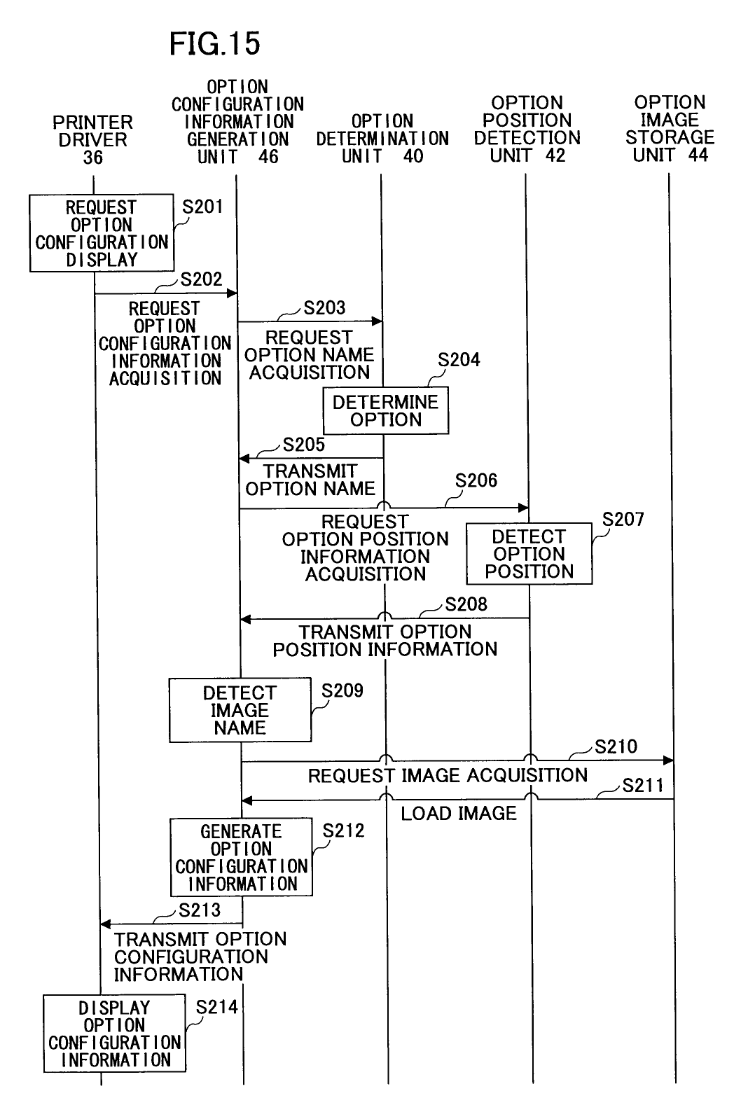

FIG. 15 is a flowchart of an option information display operation of the PC 10 and the printer 12 as illustrated in FIGS. 1-5 according to this embodiment.

At step S201, the option information display operation starts with reception at the PC 10 of a request for displaying an option configuration of the printer 12 from a user via an input device (not shown) such as a mouse and a keyboard. At step S202, upon receiving this request, the printer driver 36 requests the printer 12 to acquire option configuration information. The printer 12 uses the communication unit 48 to receive the acquisition request for the option configuration information to the printer 12. The printer 12 receives the request for acquiring the option configuration information from the printer driver 36 via the communication unit 48 and then requests the option configuration information generation unit 46 to generate option configuration information.

At step S203, the option configuration information generation unit 46 requests the option determination unit 40 to determine options currently mounted to the printer 12. Specifically, the option configuration information generation unit 46 requests the option determination unit 40 to acquire the device names of the options currently mounted. At step S204, upon receiving the request, the option determination unit 40 acquires the device names from the options in order to determine which options are currently mounted to the printer 12. Next, at step S205, the option determination unit 40 transmits the acquired option device names to the option configuration information generation unit 46.

At step S206, the option configuration information generation unit 46 requests the option position detection unit 42 to acquire position information of the options currently mounted to the printer 12. At step S207, upon receiving the request, the option position detection unit 42 detects the positions of the options currently mounted to the printer 12 by setting the position of the printer 12 as a reference position. Next at step S208, the option position detection unit 42 transmits the position information indicative of the detected option positions to the option configuration information generation unit 46.

At step S209, the option configuration information generation unit 46 detects image names of respective images adapted for the current option configuration of the printer 12 based on the device names and the position information of the options as acquired in the previous steps. Specifically, the option configuration information generation unit 46 searches the option image storage unit 44 for image names of option images of the device names acquired from the option position detection unit 42. The option images further include the position information acquired from the option position detection unit 42. Next at step S210, the option configuration information generation unit 46 requests the option image storage unit 44 to acquire an image of the printer 12 as well as option images of the detected image names. Then at step S211, the option configuration information generation unit 46 loads the printer image and the target option images from the images stored in the option image storage unit 44 in advance.

At step S212, the option configuration information generation unit 46 generates option configuration information based on the images acquired from the option image storage unit 44.

At step S213, the printer 12 uses the communication unit 48 to transmit the option configuration information generated by the option configuration information generation unit 46 to the PC 12 requesting the option configuration information.

At step S214, the printer driver 36 of the PC 10 uses the option configuration display unit 366 to display an image to represent the option configuration of the printer 12 on a display (not shown) based on the option configuration information acquired from the printer 12.

The image name detection operation of the step S209 of FIG. 15 will be described in detail below.

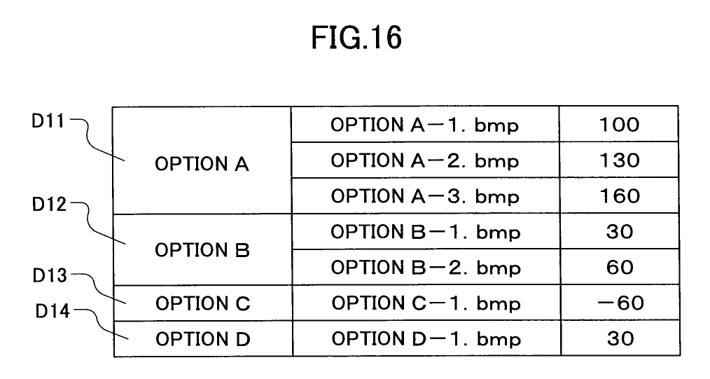

FIG. 16 shows an exemplary image name detection table stored in the image name detection table storage unit 430 of the option configuration information generation unit 46. The image name detection table may be configured as a correspondence table between position coordinates of options and image names of the options in the case of the options being positioned at the position coordinates. In this embodiment, as illustrated in FIG. 16, the image name detection table includes data D11, D12, D13 and D14 regarding the options A, B, C and D, respectively.

In the illustration of FIG. 16, the data D11 includes for the option A the position coordinates “100”, “130” and “160” as well as the image names corresponding to the respective position coordinates “option A-1.bmp”, “option A-2.bmp” and “option A-3.bmp”. For example, an image of the image name “option A-1.bmp” may be an image of the option A for which the position information of the corresponding position coordinate “100” is reflected. Similarly, the data D12 includes for the option B the position coordinates “30” and “60” as well as the image names corresponding to the position coordinates “option B-1.bmp” and “option B-2.bmp”. The data D13 includes for the option C the position coordinate “−60” as well as the image name corresponding to the position coordinate “option C-1.bmp”. The data D14 includes for the option D the position coordinate “30” as well as the image name corresponding to the position coordinate “option D-1.bmp”.

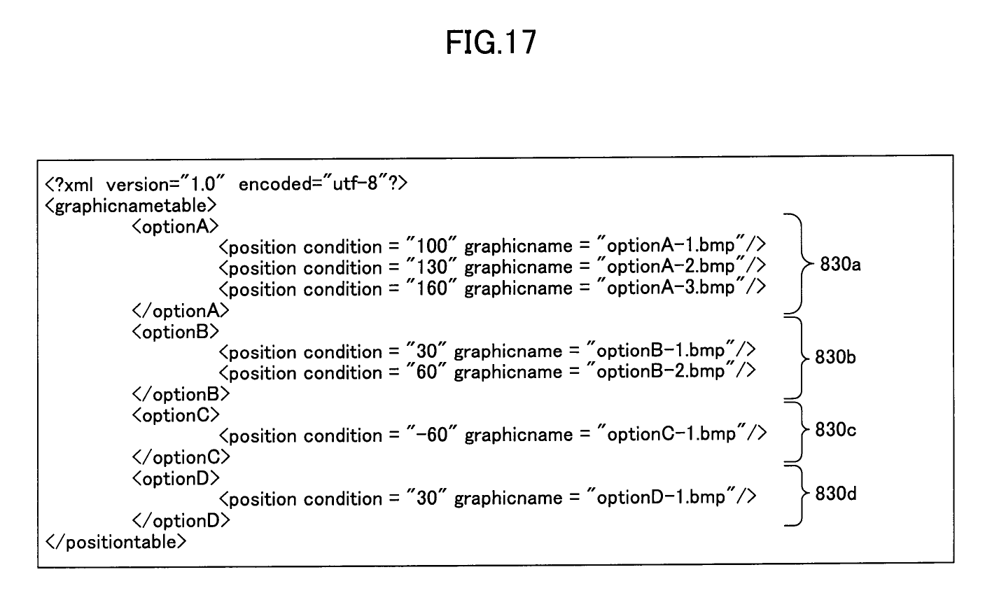

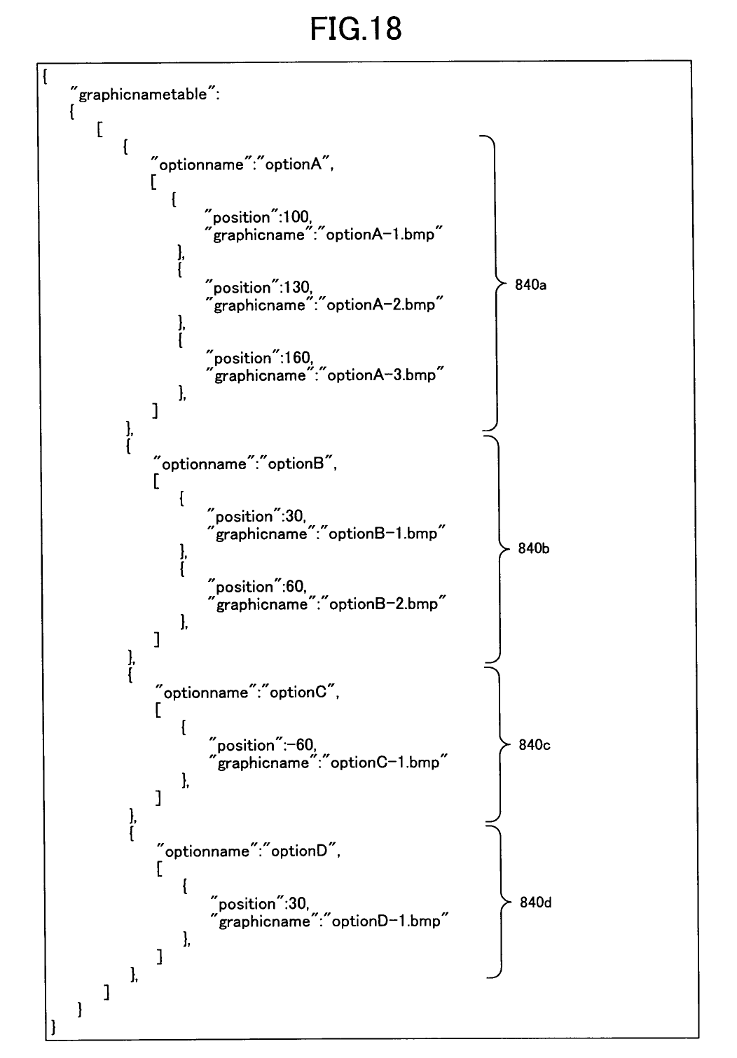

In fact, the image name detection table may be described in xml format as illustrated in FIG. 17 or in json format as illustrated in FIG. 18.

In the xml format of FIG. 17, the descriptions 830a, 830b, 830c and 830d represent the position coordinates and the corresponding image names of the options A, B, C and D, respectively. In other words, the descriptions correspond to the data D11, D12, D13 and D14 of FIG. 16. In these descriptions, the term “position” represents the position coordinate and the term “graphic” represents the corresponding image name.

In the json format of FIG. 18, the descriptions 840a, 840b, 840c and 840d represent the position coordinates and the corresponding image names of the options A, B, C and D, respectively. In other words, these descriptions correspond to the data D11, D12, D13 and D14 of FIG. 16. Similarly, in the descriptions, the term “position” represents the position coordinate, and the term “graphic” represents the corresponding image name. The description format including the xml format and the json format may be selected depending on applications.

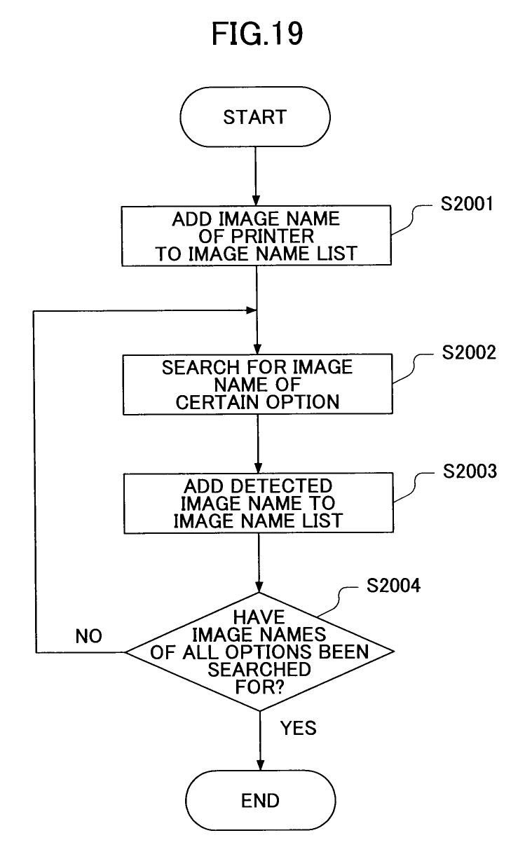

The option configuration information generation unit 46 performs the image name detection operation described in conjunction with FIG. 19 based on the image name detection table described in conjunction with FIGS. 16-18 as well as the device name and the position information of the options. FIG. 19 is a flowchart of an exemplary image name detection operation according to this embodiment.

The image name detection operation of FIG. 19 starts with reception at the option configuration information generation unit 46 of option position information from the option position detection unit 42.

At step S2001, the option configuration information generation unit 46 adds the image name of the printer 12 to a list of image names subsequently returned as a return value. At step S2002, the option configuration information generation unit 46 extracts the position coordinate of one option from the option position information acquired at the previous steps S206-S208. The option configuration information generation unit 46 uses the image detection unit 420 to detect the image name corresponding to the extracted position coordinate from the image name detection table. Next at step S2003, the option configuration information generation unit 46 adds the detection result to the image name list. At step S2004, the option configuration information generation unit 46 determines whether the image names have been searched for the positional coordinates of all the options in the option position information, and if no, the steps S2002 and S2003 are performed again. If the image names have been searched for all the position coordinates in the option position information, the option configuration information generation unit 46 returns a list of image names as a return value, and then the image name detection operation is terminated.

Next, exemplary option configuration information generated at step S212 of FIG. 15 according to this embodiment will be described in detail below.

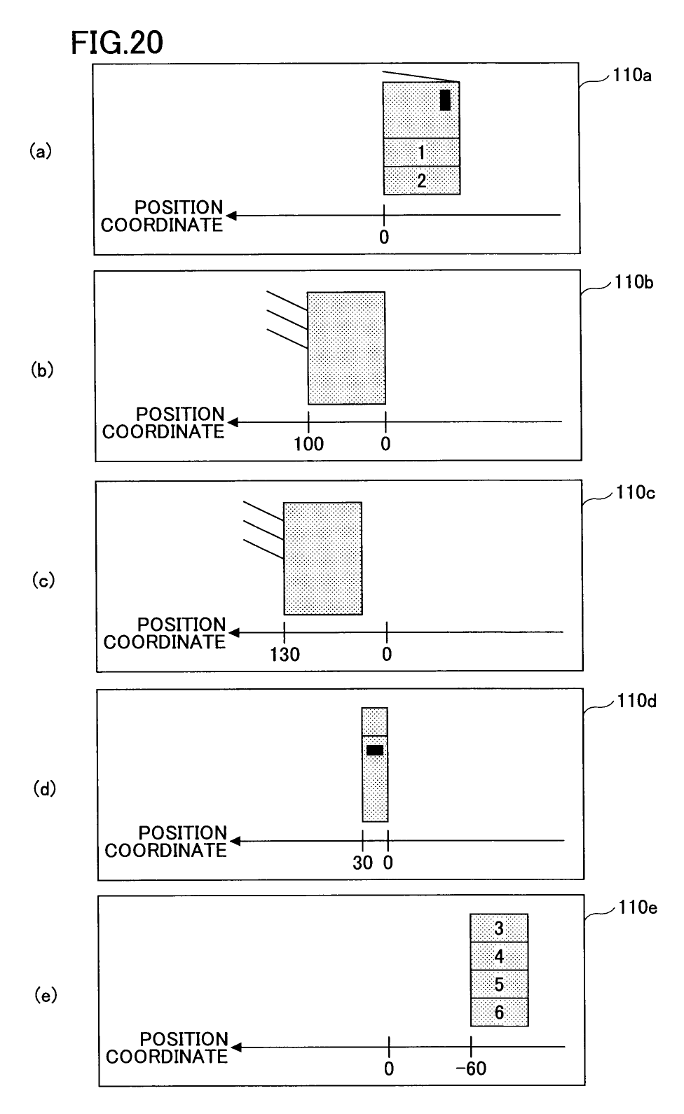

FIG. 20 shows exemplary images stored in the option image storage unit 44 of the printer 12 according to this embodiment. FIG. 20(a) shows an image 110a of the printer 12, and FIGS. 20(b)-(d) show images 110b-110d of different options that can be mounted to the printer 12. In this embodiment, if the options of a finisher, a Z-folding unit and a high-capacity input paper tray can be mounted to the printer 12, the images 110b and 110c indicate an output document ejection unit called a finisher that can automatically sort and/or staple output documents. Also, the image 110d indicates a Z-folding unit that can Z-fold output documents and the image 110e indicates a high-capacity input paper tray that may be installed separately from an input paper tray incorporated into the printer 12. These images may consist of bitmap format data (BMP file), for example.

Each of the option images 110b-110e includes position information indicative of the relative distance between the options and the reference position in the case of the reference position being set as a certain position of the printer 12, for example, as the left-side surface in respect to the front surface of the printer 12. In FIG. 11, in order to facilitate the understanding of the present invention, assuming that the left-side surface of the printer 12 is set as the reference position represented as the reference coordinate “0”, a coordinate axis indicative of the distance of the left-side surface of the options relative to the reference position is shown below the images 110a-110e of the printer 12 and the options.

The images 110b and 110c indicate the same finisher. The image 110b indicates the case where the finisher is arranged immediately adjacent to the printer 12, and the image 110c indicates the case where a Z-folding unit indicated by the image 110d is arranged between the printer 12 and the finisher. In this embodiment, three types of options, that is, a finisher, a Z-folding unit and a high-capacity input paper tray, can be mounted to the printer 12, and the two arrangements of the finisher are available. Thus, five images including an image of the printer 12 are stored in the option image storage unit 44 as illustrated in FIG. 20.

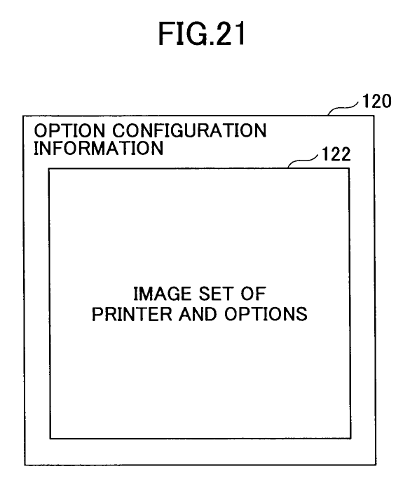

FIG. 21 shows an exemplary data structure of option configuration information generated by the option configuration information generation unit 46 of the printer 12 according to this embodiment. The option configuration information 120 of FIG. 21 includes a set of images 122 including the image of the printer 12 and images of the options currently mounted to the printer 12 where these option images include position information indicative of the distance relative to the printer 12.

Assuming that the options of the finisher, the Z-folding unit and the high-capacity input paper tray are mounted to the printer 12 and the Z-folding unit is arranged between the printer 12 and the finisher, the set of images 122 may include four of the above-mentioned five images, that is, the image 110a of the printer 12, the image 110c of the finisher in the case where the Z-folding unit is arranged between the finisher and the printer 12, the image 110d of the Z-folding unit and the image 110e of the high-capacity input paper tray.

A printer driver acquires option configuration information 120 as illustrated in FIG. 21 from the printer 12 and displays the option configuration of the target printer 12 in image form to a user. Specifically, with reference to FIG. 3, the option configuration display unit 366 of the printer driver 36 combines the images 110a, 110c, 110d and 110e of the image set 122 associated with the printer 12 and the options in the option configuration information 120 and displays an option configuration image. In this embodiment, the obtained option configuration image is the same as the image of the first embodiment as illustrated in FIG. 14.

According to an electronic device of this embodiment, an information processing apparatus does not have to possess option configuration information of the electronic device in advance analogously with the first embodiment, and even if an unknown device is mounted to the electronic device, the information processing apparatus can display the option configuration including the option device. Also, an information processing apparatus connected to an electronic device according to this embodiment can display the option configuration of the electronic device to a user by combining option images, including position information, in the option configuration information received from the electronic device.

### [Variation]

Although the preferred embodiments of the present invention have been described, the present invention is not limited to them. Many modifications and variations can be made within the spirit and scope of the present invention.

Although the electronic device of the embodiments of the present invention has been described in conjunction with the printers, the present invention can be also applied to other types of electronic devices such as a scanner and FAX as long as the electronic device may be connected as a peripheral device to an information processing apparatus enabling OS-based UIs to be displayed. Similarly, although the device driver of the embodiments of the present invention has been described in conjunction with a printer driver, the present invention can be applied to other types of device drivers such as a scanner driver and PC-FAX driver as long as the device driver consists of software for converting instructions received from the applications into device processable data. Furthermore, the present invention is not limited to any device driver and similar modules and may be applicable to the applications themselves.

Although the position information of an option device according to the embodiment of the present invention is represented as having one-dimensional coordinates, the position information of other embodiments of the present invention may be represented as having two-dimensional or three-dimensional coordinates.

Furthermore, the present invention can be implemented not only in hardware items but also in programs stored in some type of memory such as HDD (Hard Disk Drive) or ROM (Read Only Memory).

The present invention is not limited to the specifically disclosed embodiments, and variations and modifications may be made without departing from the scope of the present invention.

The present application is based on Japanese priority applications No. 2007-065590 filed Mar. 14, 2007 and No. 2008-024343 filed Feb. 4, 2008, the entire contents of which are hereby incorporated herein by reference.

What is claimed is:

1. An electronic device connected to an information processing apparatus having a display unit, one or more option devices being mounted to the electronic device, the electronic device comprising:
a storage unit storing respective device information items of the electronic device and the option devices;
an option determination unit determining which option device is currently mounted to the electronic device;
an option position detection unit detecting a position of the option device determined by the option determination unit relative to the electronic device; and
an option configuration information generation unit generating option configuration information for displaying on the display unit of the information processing apparatus based on the device information items in the storage unit, a determination result of the option determination unit and the position of the option device detected by the option position detection unit.

2. The electronic device as claimed in claim 1, wherein
the device information items comprise respective images of the electronic device and the option devices.

3. The electronic device as claimed in claim 2, wherein
the option configuration information generation unit acquires an image of the electronic device and an image of the option device determined by the option determination unit from the storage unit and further acquires position information indicative of the position of the option device detected by the option position detection unit in order to generate the option configuration information, and
the option configuration information comprises the image of the electronic device and the image and the position information of the option device currently mounted to the electronic device.

4. The electronic device as claimed in claim 2, wherein
the image of the option device stored in the storage unit comprises position information of one or more positions where the option device is allowed to be mounted to the electronic device,
the option configuration information generation unit acquires the image of the electronic device and the image of the option device determined by the option determination unit from the storage unit so as to generate the option configuration information, the image of the option device comprises position information corresponding to the position of the option device detected by the option position detection unit, and
the option configuration information comprises the image of the electronic device and the image including the position information of the option device currently mounted to the electronic device.

5. The electronic device as claimed in claim 1, wherein
the device information items are stored in the storage unit in compressed form.

6. An electronic device connected to an information processing apparatus having a display unit, one or more option devices being mounted to the electronic device, the electronic device comprising:
storage means for storing respective device information items of the electronic device and the option devices;
option determination means for determining which option device is currently mounted to the electronic device;
option position detection means for detecting a position of the option device determined by the option determination means relative to the electronic device; and
option configuration information generation means for generating option configuration information for displaying on the display unit of the information processing apparatus based on the device information items in the storage means, a determination result of the option determination means and the position of the option device detected by the option position detection means.

7. The electronic device as claimed in claim 6, wherein
the device information items comprise respective images of the electronic device and the option devices.

8. The electronic device as claimed in claim 7, wherein
the option configuration information generation means comprises acquiring an image of the electronic device and an image of the option device determined by the option determination means from the storage means and further acquiring position information indicative of the position of the option device detected by the option position detection means so as to generate the option configuration information, and
the option configuration information comprises the image of the electronic device and the image and the position information of the option device currently mounted to the electronic device.

9. The electronic device as claimed in claim 7, wherein
the image of the option device stored in the storage means comprises position information of one or more positions where the option device is allowed to be mounted to the electronic device,
the option configuration information generation means comprises acquiring the image of the electronic device and the image of the option device determined by the option determination means from the storage means in order to generate the option configuration information, the image of the option device comprising position information corresponding to the position of the option device detected by the option position detection means, and
the option configuration information comprises the image of the electronic device and the image including the position information of the option device currently mounted to the electronic device.

10. The electronic device as claimed in claim 6, wherein
the device information items are stored in the storage means in compressed form.

11. A recording medium comprising one or more instructions which, when executed by an electronic device connected to an information processing apparatus having a display unit, one or more option devices being mounted to the electronic device, cause the electronic device to perform the steps of:
storing respective device information items of the electronic device and the option devices;
determining which option device is currently mounted to the electronic device;
detecting a position of the option device determined in the determination step relative to the electronic device; and
generating option configuration information for displaying on the display unit of the information processing apparatus based on the device information items, a determination result of the determination step and the position of the option device detected in the detection step.
